(19) United States
(12) Patent Application Publication
(10) Pub. No.: US 2008/0244023 A1
(43) Pub. Date: Oct. 2, 2008

(54) METHODS AND SYSTEMS FOR PERFORMING SERVER-BASED MOBILE CHAT

(75) Inventors: Isaac David Guedalia, Bet Shemesh (IL); Jacob Guedalia, Newton, MA (US); Doron Zehavi, Shimshon MP (IL); Gerald Rovnick, Shimshon MP (IL); Barak Ginat, Neve Daniel (IL)

Correspondence Address: PEPPER HAMILTON LLP, ONE MELLON CENTER, 50TH FLOOR, 500 GRANT STREET, PITTSBURGH, PA, 15219, US

(73) Assignee: ISKOOT INC., Cambridge, MA (US)

(21) Appl. No.: 12/059,486

(22) Filed: Mar. 31, 2008

Related U.S. Application Data
(60) Provisional application No. 60/908,726, filed on Mar. 29, 2007.
(60) Provisional application No. 61/024,524, filed on Jan. 29, 2008.

(51) Int. Cl. G06F 15/16

(52) U.S. Cl. 709/206; 709/228; 709/204

(57) ABSTRACT

A method of conserving client resources associated with a mobile device may include receiving a data message for an intended subscriber of a mobile solution provider, storing the data message in a computer readable storage medium, and, in response to receiving the data message, determining whether a TCP socket can be opened with a mobile device associated with the intended subscriber. If a TCP socket can be opened, the method may include opening a TCP socket with the mobile device and sending to the mobile device one or more instructions for activating the mobile device. A request for data transfer may be received from the mobile device, and the data message may be retrieved from the computer-readable storage medium. The data message may be sent to the mobile device over the TCP socket.

### CROSS REFERENCE TO RELATED APPLICATIONS

This application claims priority under 35 U.S.C. § 119(e) to U.S. Provisional Application No. 60/908,726, filed Mar. 29, 2007, and U.S. Provisional Application No. 61/024,524, filed on Jan. 29, 2008, each of which is incorporated by reference herein in its entirety.

### BACKGROUND

Mobile communication device users may experience a variety of communication issues that are not present in PC to PC communication. For example, limited battery power, unstable connectivity and routing obstacles, such as firewalls, are problems that mobile users may encounter. If a mobile device loses connectivity, chat sessions that are in progress may be terminated, and information associated with the chat session may be erased. As such, re-creating the chat session once connectivity is re-established is difficult.

Often in chat environments, the client and the server are connected from the time of client logon to client logoff. However, if the client loses connectivity for a period of time, the server is not aware that the client is no longer receiving messages. Even when the client regains connectivity, the information that was not transmitted for the period of time the client was unavailable is usually not pushed to the client until the next server update. As such, the client may not receive messages reliably or quickly.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

In an embodiment, a method of conserving client resources associated with a mobile device may include receiving a data message for an intended subscriber of a mobile solution provider, storing the data message in a computer readable storage medium, and, in response to receiving the data message, determining whether a TCP socket can be opened with a mobile device associated with the intended subscriber. If a TCP socket can be opened, the method may include opening a TCP socket with the mobile device and sending to the mobile device one or more instructions for activating the mobile device. A request for data transfer may be received from the mobile device, and the data message may be retrieved from the computer-readable storage medium. The data message may be sent to the mobile device over the TCP socket.

In an embodiment, a method of conserving client resources associated with a mobile device may include receiving a data message for an intended subscriber of a mobile solution provider, where the intended subscriber is associated with the mobile device, storing the data message in a computer-readable storage medium and sending information to a push server. The information may include a session identification associated with the mobile device and an indication that a refresh is needed. A request for data transfer may be received by the mobile device and the data message may be sent to the mobile device.

In an embodiment, a method of restoring a chat session on a mobile device may include initiating a chat session between a mobile device associated with a first subscriber of a mobile solution provider and a mobile device associated with a second subscriber of the mobile solution provider and sending a first chat identification and a second chat identification to the mobile device associated with the first subscriber. The first chat identification may be provided by a communication service, and the second chat identification may be provided by the mobile solution provider. The method may include determining whether a chat message is received after a chat session between the first subscriber and the second subscriber has ended and if so, restoring the chat session on the mobile device associated with the first subscriber.

### BRIEF DESCRIPTION OF THE DRAWINGS

Aspects, features, benefits and advantages of the present invention will be apparent with regard to the following description and accompanying drawings, of which:

FIG. 1 illustrates an exemplary system for connecting a mobile device to a mobile solution provider via a telecommunication entity according to an embodiment.

FIG. 2 illustrates a flow chart of an exemplary method of connecting a mobile device to a mobile solution provider according to an embodiment.

FIG. 3 illustrates an exemplary system for communicating between a mobile device and a server according to an embodiment.

FIG. 4 illustrates a flow chart for an exemplary method of communicating between a mobile device and a server according to an embodiment.

FIG. 5 illustrates an exemplary system for communicating between a mobile device and a network via an SMS channel according to an embodiment.

FIG. 6 illustrates an exemplary system of communicating between a server and a mobile device via an SID port.

FIG. 7 illustrates a flow chart of an exemplary system of communicating between a server and a mobile device via an SID port according to an embodiment.

FIG. 8 illustrates an exemplary system for restoring mobile chat according to an embodiment.

FIG. 9 illustrates a flow chart of an exemplary method of restoring mobile chat according to an embodiment.

### DETAILED DESCRIPTION

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

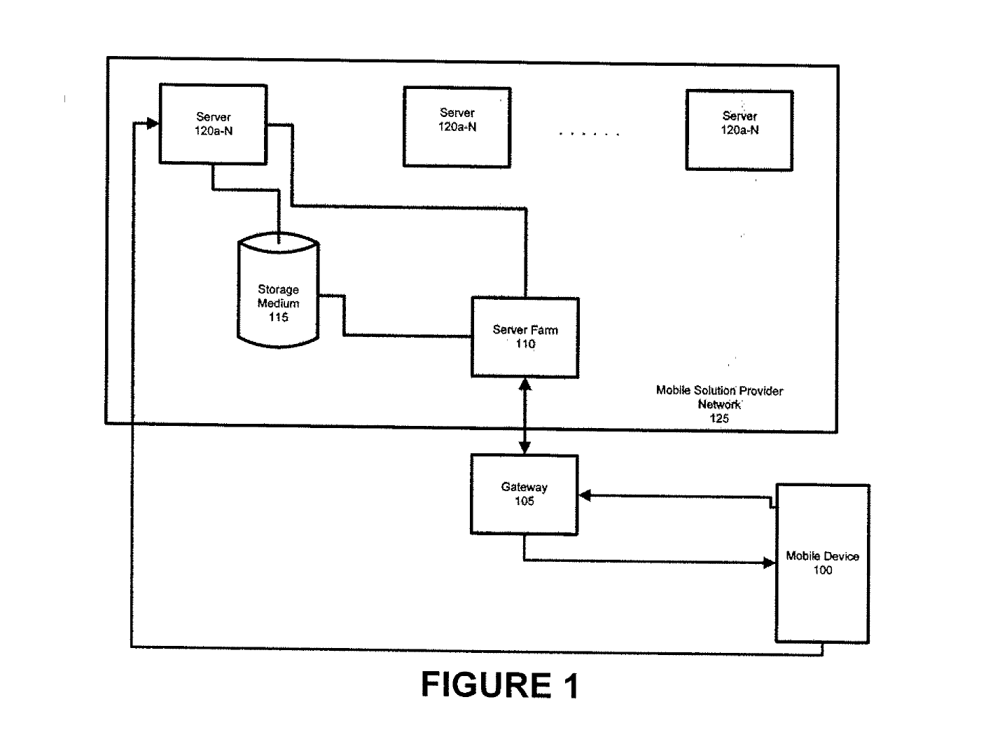

FIG. 1 illustrates an exemplary system for connecting a mobile device to a mobile solution provider via a telecommunication entity according to an embodiment. In an embodiment, a mobile solution may refer to a Voice over IP (“VoIP”) software program or application that may be used to communicate across IP based networks.

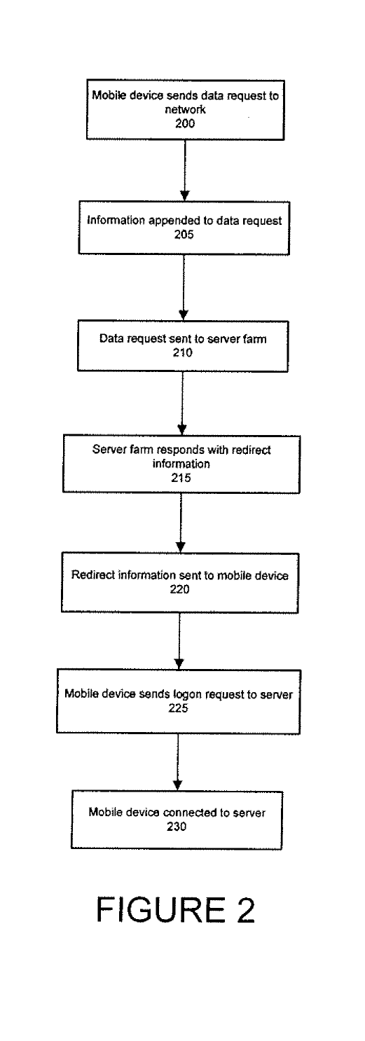

FIG. 2 illustrates a flow chart of an exemplary method of connecting a mobile device to a mobile solution provider according to an embodiment.

In an embodiment, a mobile device 100 may include a cellular phone, a PDA, a media player or the like. A mobile device 100 may have a processor and a processor-readable storage medium in communication with the processor. A mobile device may comprise a wireless client. In an embodiment, a mobile device 100 may be activated. Activation may include switching the mobile device 100 from an “off” mode to an “on” mode, switching the mobile device 100 from a “sleep” mode to an “on” mode, switching the mobile device 100 from any other dormant state to any other active state, and/or the like. In an embodiment, the mobile device 100 may be activated by a user, by an external device, by the mobile device 100 and/or the like.

Once a mobile device 100 is activated, the mobile device 100 may send 200 a data request to “logon” to a network 125. In an embodiment, the network 125 may be associated with a mobile solution provider. As illustrated by FIG. 1, the mobile device 100 may send a data request, such as an HTTP request, to the network 125 via a gateway 105. In an embodiment, the gateway 105 may serve as an intermediary between the network 125 and a telecommunication entity. For example, the gateway may be a service delivery framework. In an embodiment, the gateway may allow for multi-supplier service delivery.

In an embodiment, the gateway 105 may append 205 certain information associated with the mobile device 100 and/or the mobile device user to the data request. For example, in an embodiment, the gateway 105 may append 205 one or more of a MSISDN number, a mobile country code (“MCC”), a mobile network code (“MNC”) and/or the like to the data request. An MSISDN number may be a unique number that may be used to identify a subscription in a mobile network. A MCC may be a unique numerical code that may be used to identify one or more mobile stations in a wireless telephone network. In an embodiment, a MNC may be a numerical code that may be used in conjunction with a MCC to uniquely identify a mobile phone operator, carrier and/or the like.

In an embodiment, the gateway 105 may send 210 the data request to a server farm 110, which may respond 215 to the gateway 105 with redirect information such as a session identification (“SID”), a redirect command or the like.

In an embodiment, the SID may be a unique identifier associated with a calling period. The SID may remain valid for the length of an entire calling period, which, in an embodiment, may be the period of time from when the application is powered up and connected until the time that the application is powered down. In an embodiment, the gateway 105 may send 220 the redirect information to the mobile device 100.

In an embodiment, a network 125 associated with a mobile solutions provider may include a plurality of servers 120a-N and/or other computing devices. In an embodiment, the servers may be application servers and/or the like. A redirect command may include one or more instructions that identify a particular server 120a-N in the network 125. For example, the redirect command may include one or more of an identifier, an address and/or the like associated with the server 120a-N.

In an embodiment, a server farm 110 may include a plurality of servers and/or other computing devices. The server farm 110 may be maintained by the mobile solution provider. In an embodiment, the server farm 110 may perform a health check on the server 120a-N identified in the redirect command. In an embodiment, the server farm 110 may query the identified server 120a-N to determine whether the server 120a-N is available and performing as expected. If an identified server 120a-N fails the health check, the server farm 110 may issue a new redirect command identifying a different server 120a-N.

In an embodiment, the mobile device 100 may send 225 a logon request to the identified server 120a-N. In an embodiment, the logon request may include the SID provided by the server farm 110. When the identified server 120a-N receives the logon request, the server 120a-N may determine one or more of the IP address associated with the mobile device 100, the SID and/or the like, and may store this information in a storage medium 115, such as a database, associated with the server 120a-N. The mobile device 100 may be connected 230 to the server 120a-N.

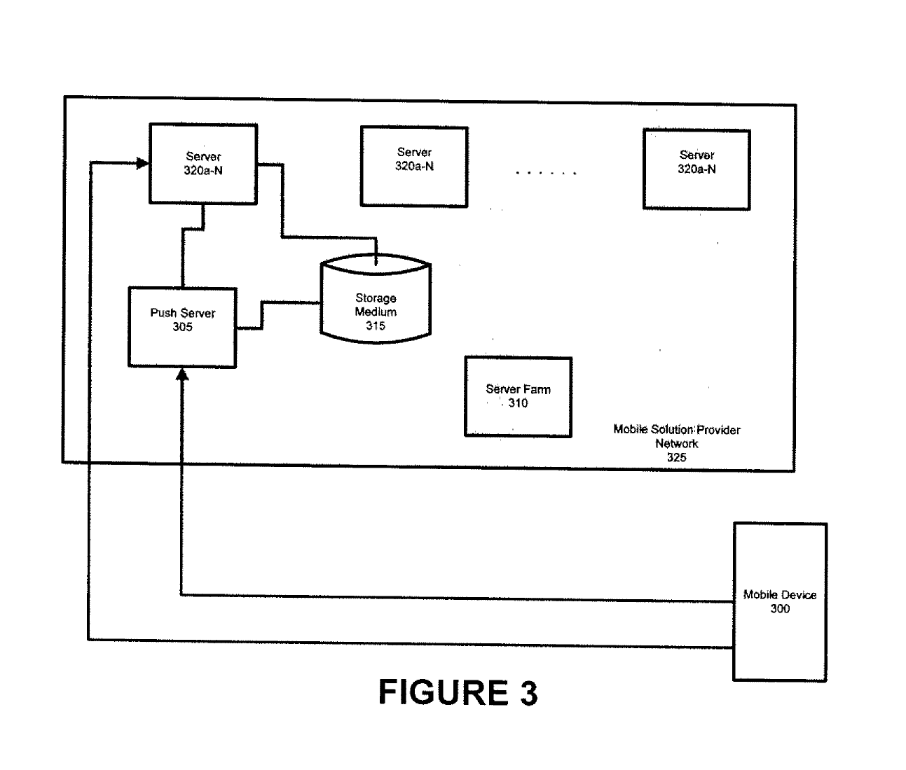

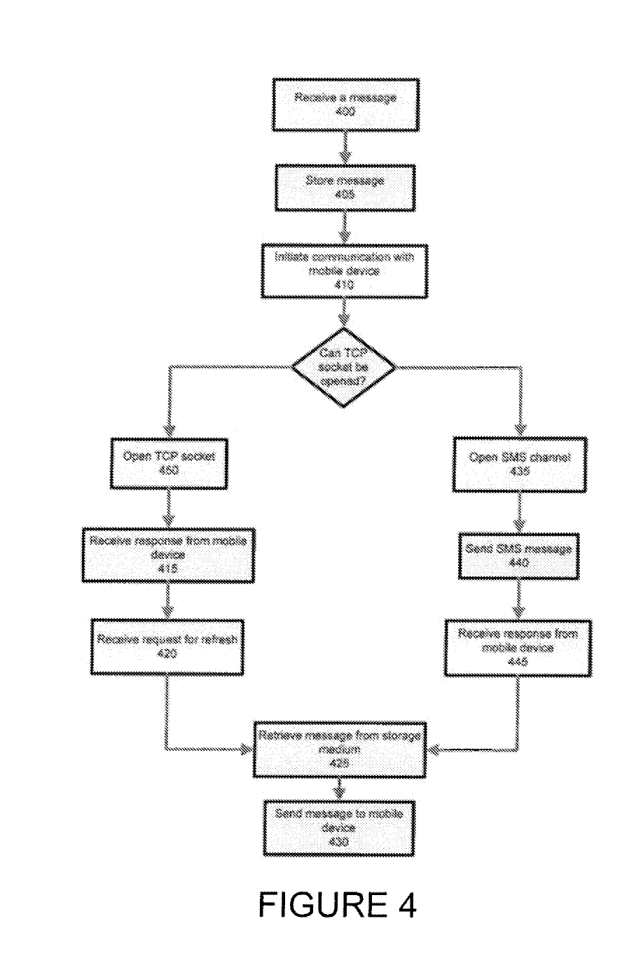

In an embodiment, the server may initiate communication with the mobile device. FIG. 3 illustrates an exemplary system for communicating between a mobile device and a server according to an embodiment. FIG. 4 illustrates a flow chart for an exemplary method of communicating between a mobile device and a server according to an embodiment.

In an embodiment, a server 320n-N associated with the mobile solution provider may initiate communication with the mobile device 300 to transmit information to the mobile device 300. In an embodiment, the server 320a-N may receive 400 a message for delivery to the mobile device 300. In an embodiment, the message may be received from a communication service. In an embodiment, a communication service may refer to a software program or application that allows subscribers to place telephone calls over the Internet to other subscribers, landlines, mobile phones and/or the like. A communication service may also offer additional features including, but not limited to, instant messaging, file transfer, short message service, video conferencing and/or the like. In an embodiment, the message may be intended for a subscriber of the mobile solution provider, a subscriber of the communication service and/or the like.

The message may be a data message, such as a text message, an instant message, a chat message and/or the like. In an embodiment, the server 320a-N may store 405 the message in a storage medium 315 associated with the server 320a-N. For example, when the server 320a-N receives a message for delivery to the mobile device 300, the server 320a-N may store 405 the message and attempt to wake up the mobile device 300 as it may have been in a sleep mode. In an embodiment, a sleep mode may preserve certain client resources associated with the mobile device 300, such as battery power and/or the like.

In an embodiment, the server 320a-N may initiate 410 communication with the client by opening 410 a TCP socket with the mobile device 300. In an embodiment, one or more of the SID and IP address of the mobile device 300 may be used to open 450 the TCP socket. Once the TCP socket has been opened, the mobile device 300 may act as a socket server. A socket server may be computer communications end point for incoming communications. As such, the mobile device 300 may respond 415 to the server via the TCP socket. For example, the mobile device 300 may send information to the server informing the server 320a-N that the mobile device 300 is active and ready to receive data.

In an embodiment, the server 320a-N may be in communication with a push server 305. In another embodiment, the server 320a-N may act as push server. The push server 305 may push information to the mobile device 300. The push server 305 may record certain information associated with each event. In an embodiment, an event may be an attempt to initiate communication with the mobile device 300. For example, the push server 305 may send one or more instructions for activating the mobile device 300. In an embodiment, a wake up message may be sent to the mobile device 300. In an embodiment, a wake up message may trigger the mobile device 300 to transition from a dormant state to an active state.

The push server 305 may record the SID of the mobile device 300, the number of retries that have been initiated, an identifier associated with the event, a time associated with the event and/or the like. Table 1 illustrates exemplary information that may be recorded by the push server.

TABLE 1

| <SID> | Event | Times Tried | Refresh |
|---|---|---|---|
| 454 | Wakeup | 3 | X |

In an embodiment, the push server 305 may be associated with a maximum retry number. Once the push server 305 has attempted to initiate communication with the mobile device 300 a number of times equal to the maximum retry number, the push server 305 may cease its attempts to contact the mobile device 300.

In an embodiment, once the push server 305 successfully initiates communication with the mobile device 300, the mobile device 300 may send 420 a request, such as a request for data transfer, to the server 320a-N. In an embodiment, the request for data transfer may be a request for a refresh of information. The server 320a-N may retrieve 425 the data message from the storage medium 315 and may send 430 the data message to the mobile device 300.

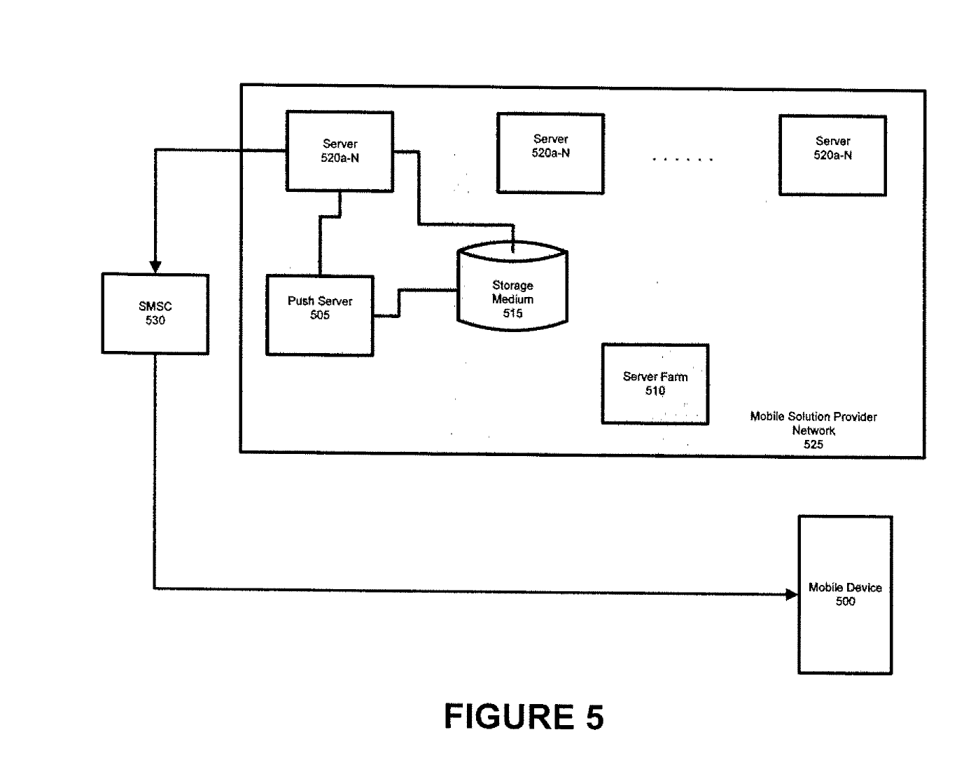

In an embodiment, it may not be possible to open 450 a TCP socket between the server and the mobile device. For example, a TCP socket may not be opened if connectivity with the mobile device is blocked by a firewall, if the mobile device has no or low battery power and/or the like. In an embodiment, if a TCP socket is unable to be opened, an SMS channel may be opened 435 between the server and the mobile device. FIG. 5 illustrates an exemplary system for communicating between a mobile device and a network via an SMS channel according to an embodiment.

In an embodiment, an SMS message may be sent 440 from a server 520a-N associated with a network 525 to a mobile device 500. The SMS message may be a wake up message or may otherwise include one or more instructions to activate, or “wake up”, the mobile device 500. In an embodiment, the SMS message may be sent 440 to the mobile device via a short message service center (“SMSC”) 530. A SMSC 530 may deliver SMS messages to recipients. In an embodiment, the server 520a-N may send the message via an SMS protocol to the SMSC 530. The SMSC 530 may send the SMS message to the mobile device 500.

If the mobile device 500 receives the SMS message, the server 520a-N may receive 445 a response from the mobile device 500. In an embodiment, the mobile device 500 may ping the server 520a-N to acknowledge receipt of the message. The server 520a-N may retrieve 425 the received message from the storage medium 515 and may send 430 the message to the mobile device 500.

In other communication environments, such as chat environments, the mobile device and server may be connected from logon until log off. However, the server usually only attempts to activate, or wake, the mobile device after certain predetermined periods of time, such as every half an hour. The assumption behind this approach is that any message that is received will be transmitted along the constantly open data channel from the server to the mobile device. However, if the mobile device loses connectivity, the server cannot detect that the mobile device is unable to receive messages. Even when connectivity is restored, the information that was un-transmitted for the period of unavailability is usually not pushed to the mobile device until the next server update. As such, the mobile device is not guaranteed to receive messages reliably or quickly.

Activating and communicating with the mobile device when there is a message to be sent and/or having the mobile device ping the server to request data transfer may conserve client resources, such as battery power. In addition, because the push server may continually attempt to wake the mobile device, if the mobile device is unavailable for a period of time, the mobile device may receive any information that was received during this time when connectivity is restored rather than a next refresh period.

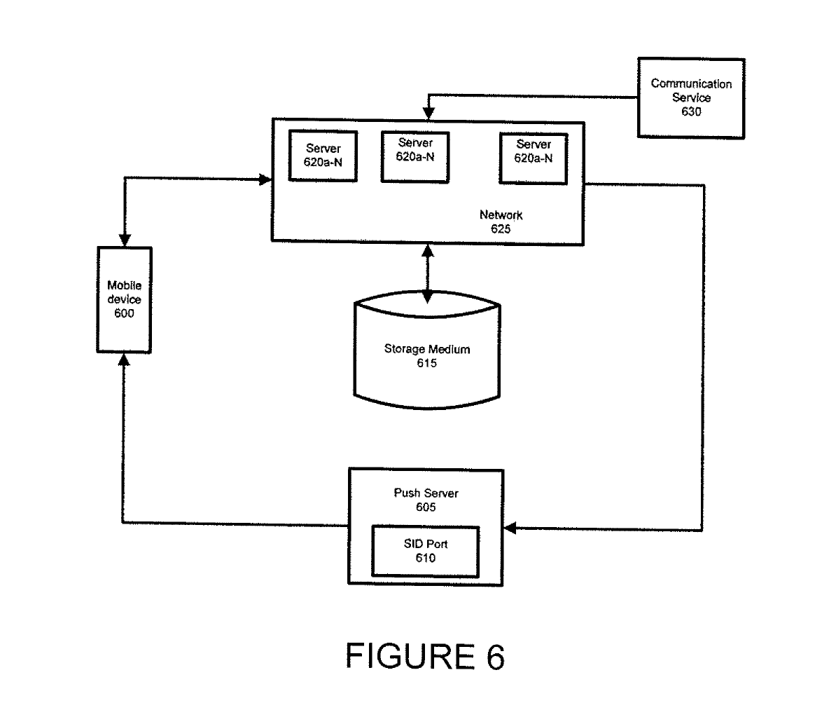

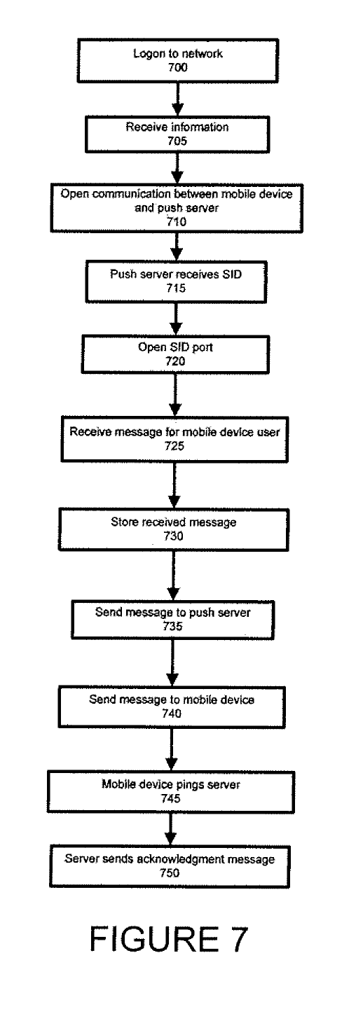

In an embodiment, communication between a server and a mobile device may be opened via a SID port on a push server. FIG. 6 illustrates an exemplary system of communicating between a server and a mobile device via an SID port on a push server. FIG. 7 illustrates a flow chart of an exemplary system of communicating between a server and a mobile device via an SID port on a push server according to an embodiment.

In an embodiment, when the mobile device 600 logs 700 on to the network 625, the mobile device 600 may receive 705 certain information. This information may include an indication of where an communication service application is running, an indication of where to send data requests, an indication of which push server the mobile device is assigned to and/or the like. A connection between the mobile device 600 and a push server 605 may be opened 710. For example, the mobile device 600 may initiate an HTTP request to the push server 605.

In an embodiment, the SID associated with the mobile device 600 may be communicated 715 to the push server 605. In an embodiment, the SID may be communicated as one or more parameters in an HTTP request to the push server 605. A SID port 610 on the push server 605 may be opened 720. The SID port 610 may enable the server 620a-N to communicate with the push server 605. This may enable two modes of communication to and from the push server 605. For example, the server 620a-N may be able to communicate information to and from the communication service 630 via the SID port 610. In addition, communication to and from the mobile device 600 may be possible via the connection established by the mobile device 600. In an embodiment, the connection between the mobile device 600 and the push server 605 may be a persistent connection that may remain open. In an embodiment, the connection may remain open until the push server 605 receives a message, such as an acknowledgement message. In an embodiment, an acknowledgement message may include one or more instructions notifying the push server 605 to stop sending messages to the mobile device 600.

In an embodiment, a server 620a-N associated with the network 625 may receive 725 one or more data messages. In an embodiment, the data messages may be intended for a subscriber of the mobile solution provider, the communication service and/or the like. The data messages may be text messages, instant messages, chat messages and/or the like. In an embodiment, the server 620a-N may store 730 the received messages in a storage medium 615 associated with the server 620a-N. The sever 620a-N may send 735 a message to the push server 605 that may include the SID of the intended mobile device 600 and one or more instructions for sending a wakeup message to the mobile device. In an embodiment, the wakeup message may prompt the mobile device to request a refresh in order to receive new information.

In response, the push server 605 may send 740 the message to the mobile device 600. The mobile device 600 may ping 745 the server 620a-N to receive the stored messages. In an embodiment, after the stored messages are transmitted to the mobile device 600, the server 620a-N may send 750 an acknowledgement message to the push server 605. In an embodiment, if no messages or other information is to be sent to the mobile device 600, the push server 605 may send one or more intermittent pings to the mobile device 600.

In an embodiment, information may be lost if communication between a mobile device and a server is ended. For example, mobile chat sessions may be prematurely terminated if a connection between a mobile device and a server is ended. This may occur if connectivity is lost, if a maintenance script ends the session and/or the like.

In an embodiment, a chat session may be a conversation between a plurality of mobile device users. A plurality of users may communicate in real time by sending one or more text messages to users in the same chat room. In an embodiment, a chat session may be provided in a window displayed on a user's mobile device. For example, a user may engage in multiple chat sessions in different chat rooms simultaneously, with each session being displayed in a different window on the user's mobile device. Often, information associated with a chat session is stored while the chat session is in progress. However, when a chat session ends or is terminated, the data is often erased, thus making restoring the chat session difficult.

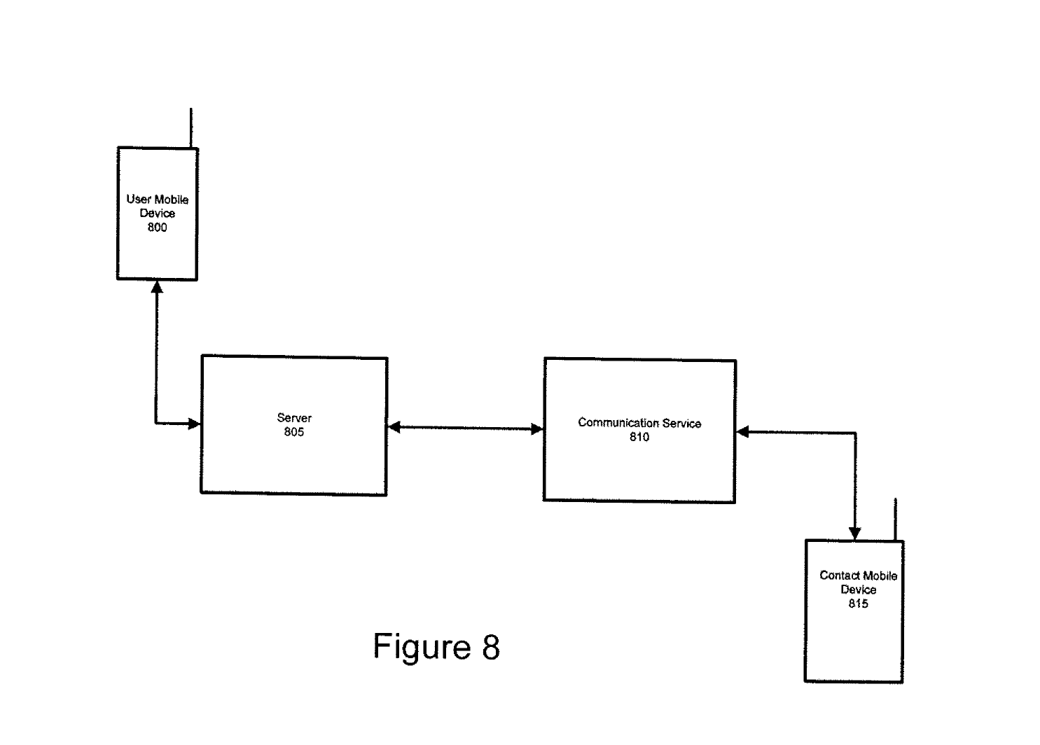

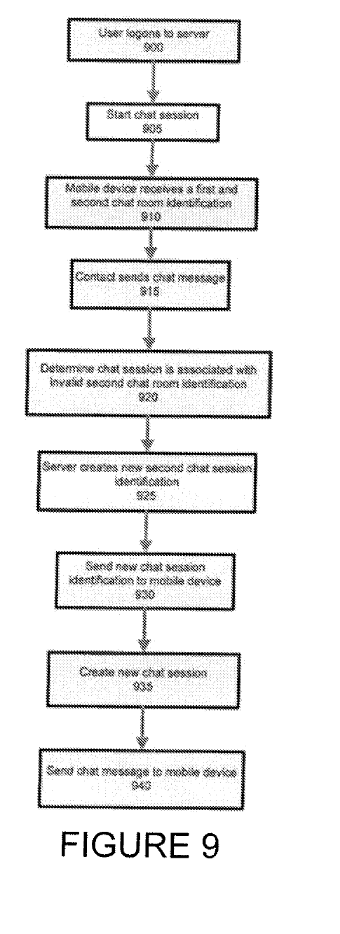

FIG. 8 illustrates an exemplary system for restoring mobile chat according to an embodiment. FIG. 9 illustrates a flow chart of an exemplary method of restoring mobile chat according to an embodiment.

In an embodiment, a user may logon 900 to a server 805 associated with a mobile solution provider via a mobile device 800. The user may then logon 900 to a communication service to begin a chat session. In an embodiment, a chat session between a mobile device 815 associated with one or more contacts from a contact list, an address book and/or the like and the user's mobile device 800 may be started 905. When a chat session is initiated, the user's mobile device 800 may receive 910 a first chat identification and a second chat identification. In an embodiment, the first chat identification may be issued by a communication service 810. In an embodiment, the second chat identification may be issued by the server 805 associated with the mobile solution provider. In an embodiment, the first and second chat identifications may be used to maintain the chat session.

In an embodiment, the contact may send 915 a chat message to the user's mobile device 800 after the chat session has ended, been terminated, failed and/or the like. The server 805 may determine 920 that the chat session is associated with a valid first chat identification, but an invalid second chat identification. The server 805 may create 925 a new second chat identification for the chat message, and may send 930 it to the mobile device 800. As such, a new chat session provisioned with the new second chat identification may be created 935, and the chat message may be sent 940 to the user's mobile device 800.

In an embodiment, a chat session may correspond to a chat session table. The chat session table may be stored on a database and/or the like associated with the server, and may include information associated with the chat session. For example, the chat session table may include one or more of a session identification, a chat session name, a chat session index and/or the like.

In an embodiment, a mobile device may use a chat session name as a chat session identifier. A chat session name may be assigned by the communication service. In an embodiment, the chat session name may be assigned by the communication service after the chat session is created. The mobile device may obtain the chat session name by requesting the name from the communication service. In an embodiment, the mobile device may use the chat session name as a default value when creating or re-creating chat sessions. In another embodiment, the mobile device may use the chat session name to create or re-create chat sessions when the mobile device receives an error message that the chat session could not be found.

In an embodiment, information associated with a chat session may be stored by a storage medium associated with a server on a mobile solution provider network. In an embodiment, at the end of a chat session, information associated with the chat session that was inherited from one or more previous chat sessions and that was not used during the last chat session may be erased from the storage medium. In an embodiment, the information associated with the last chat session that was used during the chat session may be identified as old and stored in the chat session table. In an embodiment, the stored information may include a chat session index, a chat session name and/or the like. If a mobile device attempts to open a chat session having a chat session index associated with an old chat session, the server may translate the chat session index to a chat session name. The server may use the chat session name to retrieve data associated with the chat session from the communication service and re-create the chat session on the communication service.

In an embodiment, at the end of a chat session, information identified as old may be erased from the storage medium. Information identified as new may be stored in the storage medium. In an embodiment, the server may use the new information to re-create a chat session even if the communication service erased the information associated with the session.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of conserving client resources associated with a mobile device, the method comprising:
receiving a data message for an intended subscriber of a mobile solution provider;
storing the data message in a computer readable storage medium;
in response to receiving the data message, determining whether a TCP socket can be opened with a mobile device associated with the intended subscriber;
if so:
opening a TCP socket with the mobile device, and
sending to the mobile device one or more instructions for activating the mobile device;
receiving, from the mobile device, a request for data transfer;
retrieving, from the computer-readable storage medium, the data message; and
sending the data message to the mobile device over the TCP socket.

2. The method of claim 1, further comprising:
if a TCP socket cannot be opened, opening an SMS channel with the mobile device;
sending an SMS message to the mobile device;
receiving, from the mobile device, a request for data transfer;
retrieving, from the storage medium, one or more messages to be delivered to the mobile device; and
sending the data message to the mobile device over the SMS channel.

3. The method of claim 1, wherein the data message comprises on or more of the following:
a text message;
an instant message; and
a chat message.

4. The method of claim 1, wherein sending to the mobile device one or more instructions for activating the mobile device comprises:
sending a wake up message to the mobile device.

5. The method of claim 1, wherein sending to the mobile device one or more instructions for activating the mobile device comprises:
if the request for data transfer is not received from the mobile device within a predefined period of time, repeating sending of the one or more instructions; and
each time the one or more instructions are sent, recording one or more of the following:
a session identification associated with the mobile device,
a description of the one or more instructions, and
a total number of times the one or more instructions have been sent.

6. The method of claim 5, further comprising:
repeating sending of the one or more instructions until the total number of times the one or more instructions have been sent exceeds a predefined threshold.

7. A method of conserving client resources associated with a mobile device, the method comprising:
receiving a data message for an intended subscriber of a mobile solution provider, wherein the intended subscriber is associated with the mobile device;
storing the data message in a computer-readable storage medium;
sending information to a push server, wherein the information comprises a session identification associated with the mobile device and an indication that a refresh is needed;
receiving, from the mobile device, a request for data transfer; and
sending the data message to the mobile device.

8. The method of claim 7, wherein receiving a data message comprises receiving one or more of the following:
a text message;
an instant message; and
a chat message.

9. The method of claim 7, further comprising:
sending an acknowledgement message to the push server, wherein the acknowledgement message notifies the push server that no further communication with the mobile device is necessary.

10. The method of claim 9, wherein sending an acknowledgement message comprises sending an acknowledgement message after the data message has been sent to the mobile device.

11. A method of restoring a chat session on a mobile device, the method comprising:
initiating a chat session between a mobile device associated with a first subscriber of a mobile solution provider and a mobile device associated with a second subscriber of the mobile solution provider;
sending a first chat identification and a second chat identification to the mobile device associated with the first subscriber, wherein the first chat identification is provided by a communication service, wherein the second chat identification is provided by the mobile solution provider;
determining whether a chat message is received after a chat session between the first subscriber and the second subscriber has ended; and
if so, restoring the chat session on the mobile device associated with the first subscriber.

12. The method of claim 11, wherein determining whether a chat message is received after a corresponding chat session ended comprises:
determining whether the first chat identification is valid; and
determining whether the second chat identification is invalid.

13. The method of claim 11, wherein restoring the chat session comprises:
generating a new second chat identification;
sending the new second chat identification to the mobile device associated with the first subscriber;
creating a new chat session provisioned with the new second chat identification; and
sending the chat message to the mobile device associated with the first subscriber.

14. The method of claim 11, wherein restoring the chat session comprises:
determining a chat session name associated with the chat session based on a chat session index associated with the chat session;
using the chat session name to retrieve information associated with the chat session from the communication service; and
re-creating the chat session on the mobile device of the first subscriber using the retrieved information.
